(19) United States
(12) Patent Application Publication
(10) Pub. No.: US 2025/0189750 A1
(43) Pub. Date: Jun. 12, 2025

(54) LENS ASSEMBLY

(71) Applicant: Samsung Electro-Mechanics Co., Ltd., Suwon-si (KR)

(72) Inventors: Soo Bin HA, Suwon-si (KR); Geon Hwi PARK, Suwon-si (KR); Joon JANG, Suwon-si (KR); You Jin JEONG, Suwon-si (KR)

(73) Assignee: Samsung Electro-Mechanics Co., Ltd., Suwon-si (KR)

(21) Appl. No.: 18/941,841

(22) Filed: Nov. 8, 2024

(30) Foreign Application Priority Data
Dec. 7, 2023 (KR) 10-2023-0176711

(51) Int. Cl. G02B 7/02; G02B 13/18; G03B 17/12

(52) U.S. Cl. CPC G02B 7/021; G03B 17/12; G02B 13/18

(57) ABSTRACT

A lens assembly is provided. The lens assembly includes a spacer; and a first lens coupled to the spacer, wherein a length of the first lens in a first direction, perpendicular to an optical axis, is greater than a length of the first lens in a second direction, perpendicular to both the optical axis and the first direction, the first lens includes a first side surface which extends in the first direction, the spacer includes a plurality of support portions in contact with the first lens, and a side wall portion that connects the plurality of support portions, and the first side surface of the first lens is disposed to face the side wall portion.

### CROSS-REFERENCE TO RELATED APPLICATIONS

This application claims the benefit under 35 USC § 119 (a) of Korean Patent Application No. 10-2023-0176711 filed on Dec. 7, 2023, in the Korean Intellectual Property Office, the entire disclosure of which is incorporated herein by reference for all purposes.

### BACKGROUND

### 1. Field

The following description relates to a lens assembly.

### 2. Description of Related Art

Camera module are typically implemented in portable electronic devices such as, but not limited to, smartphones.

The camera modules may be provided with a lens assembly including a plurality of lenses, and a spacer may be disposed between the plurality of lenses to maintain a gap between the lenses. In order to increase optical performance of the lens assembly, the lens may be provided with a side surface in a shape in which a portion of the lens is cut. However, structural stability of the lens assembly may be reduced due to the space between the cut side surface of the lens and the lens barrel.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a lens assembly includes a spacer; and a first lens coupled to the spacer, wherein a length of the first lens in a first direction, perpendicular to an optical axis, is greater than a length of the first lens in a second direction, perpendicular to both the optical axis and the first direction, wherein the first lens comprises a first side surface which extends in the first direction, wherein the spacer comprises a plurality of support portions in contact with the first lens, and a side wall portion that connects the plurality of support portions, and wherein the first side surface of the first lens is disposed to face the side wall portion.

The first side surface of the first lens may be disposed to be spaced apart from the side wall portion in a direction perpendicular to an optical axis.

A first protruding portion, which protrudes in a direction in which a distance from the optical axis increases, may be disposed on the first side surface of the first lens, and the first protruding portion may be disposed to be spaced apart from the side wall portion in a direction perpendicular to the optical axis.

A length of the side wall portion may be less than a length of the first side surface of the first lens.

When the length of the first side surface of the first lens is Ld, and the length of the side wall portion is Lw, Ld/2<Lw<Ld may be satisfied.

A thickness of the side wall portion in an optical axis direction may be greater than a thickness of the support portion in the optical axis direction.

The first lens may include an optical portion and a flange portion that extends from the optical portion, and a lower surface of the flange portion may be disposed closer to an image side in the optical axis direction than to a lower surface of the side wall portion.

The first lens may include an optical portion and a flange portion that extends from the optical portion, and a lower surface of the side wall portion may be disposed between the first protruding portion and a lower surface of the flange portion based on a direction parallel to the optical axis.

An inner surface of the side wall portion may include a second protruding portion which protrudes toward the optical axis, and the first protruding portion and the second protruding portion may be spaced apart from each other in a direction perpendicular to the optical axis.

When viewed from an object side, the first side surface of the first lens and an inner surface of the side wall portion may be disposed to be parallel to each other.

When viewed from an object side, an inner surface of the side wall portion may have a curved shape with a center of a radius of curvature disposed on a side of the optical axis.

In a general aspect, a lens assembly includes a lens barrel; a spacer disposed on the lens barrel; and a first lens disposed on the lens barrel and coupled to the spacer, wherein a length of the first lens in a first direction, perpendicular to an optical axis, is greater than a length of the first lens in a second direction, perpendicular to both the optical axis and the first direction, wherein a length of the first lens in a first direction, perpendicular to an optical axis, is greater than a length of the first lens in a second direction, perpendicular to both the optical axis and the first direction, wherein the spacer comprises a plurality of support portions in contact with the first lens and a side wall portion that connects the plurality of support portions, wherein the side wall portion faces the first side surface of the first lens in a direction perpendicular to an optical axis, and wherein the side wall portion is disposed to be spaced apart from an inner surface of the lens barrel in a direction perpendicular to the optical axis.

The first side surface of the first lens may be disposed to be spaced apart from an inner surface of the side wall portion in a direction perpendicular to the optical axis.

A protruding portion which protrudes toward the optical axis may be disposed on an inner surface of the side wall portion, the inner surface of the side wall portion may include an upper side surface disposed above the protruding portion, and the upper side surface may be configured to form an acute angle with a line parallel to the optical axis.

The first lens may include an optical portion and a flange portion that extends from the optical portion, and a lower surface of the support portion may be disposed in contact with an upper surface of the flange portion.

A length of the side wall portion may be less than a length of the first side surface of the first lens.

In a general aspect, a lens assembly includes a lens including cut side surfaces, and including a first length in a first direction, perpendicular to an optical axis, and a second length, less than the first length in a second direction perpendicular to both the optical axis and the first direction; and a first spacer, including support portions and sidewall portions, wherein the sidewall portions may be spaced apart from the cut side surfaces of the first lens, overlap the cut side surfaces of the first lens in a direction perpendicular to an optical axis direction, and may extend from an upper surface of the spacer toward an imaging plane.

The lens assembly may further include a second spacer disposed between a second lens and the first spacer, wherein a height of the second spacer in an optical axis direction may be less than a height of the first spacer in the optical axis direction.

Inner surfaces of the side wall portions have a curved shape with a center of a radius of curvature disposed toward the optical axis, and outer surfaces of the side wall portions have a straight shape.

Other features and aspects will be apparent from the following detailed description, the drawings, and the claims.

### BRIEF DESCRIPTION OF DRAWINGS

FIG. 1 illustrates a schematic perspective view of an example lens assembly, in accordance with one or more embodiments.

FIG. 2 illustrates a cross-sectional view taken along line I-I′ of FIG. 1.

FIG. 3 illustrates a cross-sectional view taken along line II-II′ of FIG. 1.

FIG. 4 is a perspective view illustrating a structure in which a first lens and a spacer are coupled, in accordance with one or more embodiments.

FIG. 5 is an exploded perspective view illustrating a first lens and a spacer, in accordance with one or more embodiments.

FIG. 6 illustrates a side view of a structure in which a first lens and a spacer are coupled, in accordance with one or more embodiments.

FIG. 7 illustrates an enlarged view of A in FIG. 2.

FIG. 8 illustrates another embodiment of an example lens assembly, in accordance with one or more embodiments.

FIG. 9, FIG. 10, FIG. 11, and FIG. 12 illustrate various embodiments of an example lens assembly, in accordance with one or more embodiments, illustrating a structure of a cut side surface and a side wall portion.

FIG. 13 is a perspective view illustrating another embodiment of a spacer applied to the example lens assembly, in accordance with one or more embodiments.

FIG. 14 is a plan view illustrating a spacer, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may improve a structural stability of the lens assembly by disposing a portion of the spacer between the side surface of the lens, provided in a shape in which a portion of the lens is cut, and an inner surface of the lens barrel.

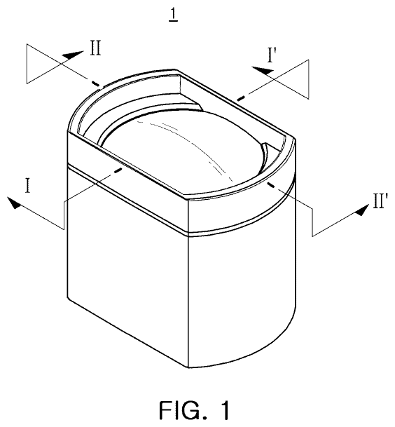

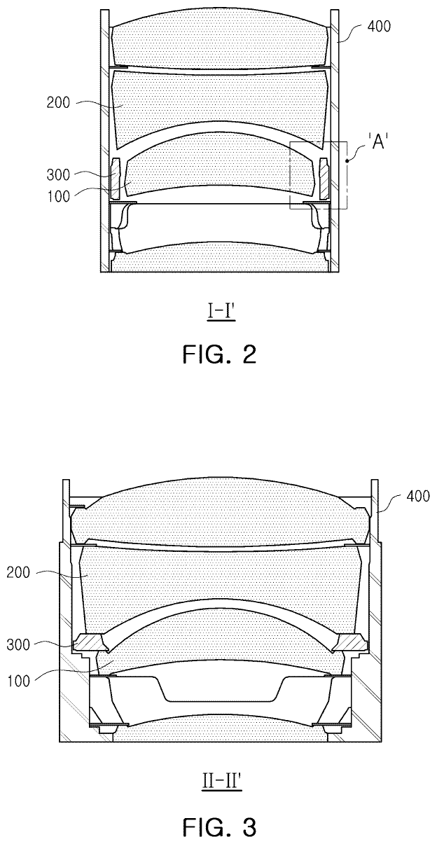

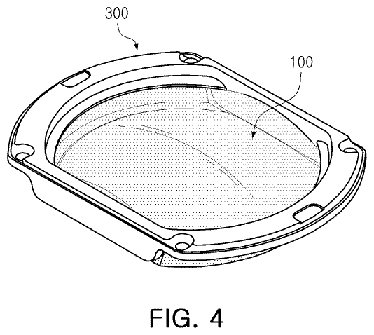

FIG. 1 illustrates a schematic perspective view of an example lens assembly, in accordance with one or more embodiments, FIG. 2 is a cross-sectional view taken along line I-I′ of FIG. 1, and FIG. 3 is a cross-sectional view taken along line II-II′ of FIG. 1.

Referring to FIGS. 1 to 3, a lens assembly, in accordance with one or more embodiments, may include a plurality of lenses, a plurality of spacers, and a lens barrel 400. In an example, since the number of lenses and the number of spacers are not limited to FIGS. 1 to 3, the number of lenses and the number of spacers may vary.

In a non-limited example, each of the plurality of lenses may be disposed to be spaced apart from respective adjacent lenses. In this example, a spacer may be disposed between each of the lenses. In other words, the spacer may separate the lenses from each other. However, since the lens may be fitted and coupled to the lens barrel, the lenses may be spaced apart from each other even if a spacer is not disposed between the lenses.

A spacer may be disposed between the plurality of lenses. The spacer may maintain a gap between the lenses and, as another effect, may block unnecessary light. That is, the spacer may be provided with a light absorption layer, and the light absorption layer may be provided with a black film or black iron oxide. In an example, the spacer may be formed of plastic or metal, but is not limited thereto.

The lens barrel 400 may include a hollow portion. The hollow portion of the lens barrel 400 may penetrate the lens barrel in an optical axis direction. A plurality of lenses and a plurality of spacers may be disposed in the hollow portion of the lens barrel 400.

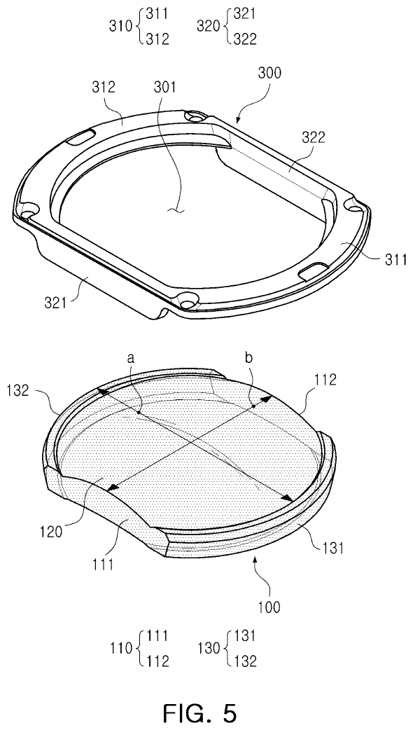

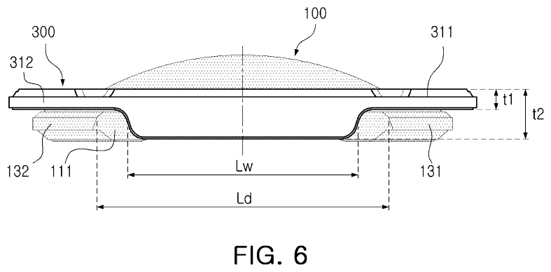

FIG. 4 is a perspective view illustrating a structure in which a first lens and a spacer are coupled, FIG. 5 is an exploded perspective view illustrating a first lens and a spacer according, in accordance with one or more embodiments, and FIG. 6 is a side view of a structure in which a first lens and a spacer are coupled, in accordance with one or more embodiments.

The first lens 100, in accordance with one or more embodiments, may be a lens having a shape in which a portion of the first lens is cut. Specifically, when viewed from an object side or an image side, the first lens 100 may have a side surface 110 (111, 112) in which a portion of the lens is cut. In this example, the first lens 100 may be referred to as a de-cut lens.

For convenience of explanation, the expression cutting is used. However, since the lens may be manufactured by injection molding, it should be noted that the expression cutting is only a manner of expressing the shape. In other words, the lens may be manufactured in a shape in which a portion of the lens is cut by injection molding.

Since the first lens 100 includes a cut side surface 110, when viewed from an object side, the first lens 100 may have a major axis (a) direction and a minor axis (b) direction. That is, when viewed from the object side, the major axis (a) direction may refer to a direction in which the length is relatively long, and the minor axis (b) direction may refer to a direction in which the length is relatively short. In an example, the major axis (a) and minor axis (b) may be perpendicular to each other. In an example, the major axis (a) direction may be referred to as a first direction, and the minor axis (b) direction may be referred to as a second direction. The first direction may be perpendicular to an optical axis, and the second direction may be perpendicular to both the first direction and the optical axis. The cut side surface 110 may be a side surface extending in the major axis (a) direction or the first direction.

The first lens 100 may include an optical portion 120 and a flange portion 130 (131, 132).

The optical portion 120 may be a portion in which the optical performance of the lens is exhibited. For example, light reflected from a subject may pass through the optical portion 120, and may be refracted. The optical portion 120 may have refractive power, and may have an aspherical shape.

The flange portion 130 may be a portion that extends from the optical portion 120. Specifically, the flange portion 130 may be a portion that extends from a side surface portion of the optical portion 120 to the outside of the optical portion 120. Although it has been described that the flange portion 130 extends from the optical portion 120, this is merely for convenience of explanation, and the flange portion 130 may be formed integrally with the optical portion 120 through injection molding.

The flange portion 130 may be disposed on opposite sides of the optical portion 120 based on the major axis (a) direction of the first lens 100. The flange portion 130 may be disposed in the major axis (a) direction with an optical axis interposed therebetween. That is, the flange portion 130 may be arranged in plurality and may include a first flange portion 131 and a second flange portion 132. In an example, the first flange portion 131 and the second flange portion 132 may be disposed in the major axis (a) direction with the optical axis interposed therebetween.

A cut side surface 110 of the first lens 100 may be disposed between the first flange portion 131 and the second flange portion 132. The cut side surface 110 may be disposed in plural. The cut side surface 110 may include a first side surface 111 and a second side surface 112.

Each of the first side surface 111 and the second side surface 112 may be a side surface that extends in the first direction. The first side surface 111 and the second surface 112 may be disposed in opposite directions with the optical axis interposed therebetween. That is, the first side surface 111 and the second side surface 112 may be disposed to be spaced apart from each other in the minor axis direction. The first side surface 111 may connect a first side of the first flange portion 131 and a first side of the second flange portion 132, and the second side surface 112 may connect a second side of the first flange portion 131 and a second side of the second flange portion 132.

When viewed from an object side of the first lens 100, the spacer 300 may have an appearance similar to that of the first lens 100. That is, the shape of the spacer 300 may be determined considering the coupling to the first lens 100. Accordingly, the spacer 300 may have a major axis (a) direction and a minor axis (b) direction.

Based on a state in which the spacer 300 and the first lens 100 are coupled, the major axis direction and the minor axis direction of the spacer 300 may correspond to the major axis (a) direction and the minor axis (b) direction of the first lens 100.

The spacer 300 may include a support portion 310 and a side wall portion 320.

The support portion 310 may refer to a region contacting the first lens 100 or the lens barrel 400 or supporting the first lens 100 or the lens barrel 400. The support portion 310 may be disposed in plural, and the plurality of support portions may be disposed to be spaced apart from each other in the major axis (a) direction. The support portion 310 may include a first support portion 311 and a second support portion 312, and the first support portion 311 and the second support portion 312 may be disposed to be spaced apart from each other with the optical axis interposed therebetween. The support portion 310 may be disposed at a position approximately corresponding to the flange portion 130 of the first lens 100.

The side wall portion 320 may have a surface that extends in the major axis (a) direction and an optical axis direction. The side wall portion 320 may have a thickness in the optical axis direction.

The side wall portion 320 may be disposed between a plurality of support portions. That is, the side wall portion 320 may connect the first support portion 311 and the second support portion 312. The side wall portion may include a first side wall portion 321 and a second side wall portion 322. The first side wall portion 321 and the second side wall portion 322 may be disposed to be spaced apart from each other in the minor axis (b) direction, and may be disposed on opposite sides of each other with the optical axis therebetween. The first side wall portion 321 may connect a first side of the first support portion 311 and a first side of the second support portion 312, and the second side wall portion 322 may be disposed to face the first side wall portion 321 and may connect a second side of the first support portion 311 and a second side of the second support portion 312.

Referring to FIG. 6, the first lens 100 and the spacer 300 may be coupled. Specifically, a portion of the first lens 100 may be disposed in an opening 301 of the spacer 300, and a portion of the spacer 300 may be disposed to surround a portion of an outer surface of the first lens 100.

The flange portion 130 of the first lens 100 may contact the support portion 310 of the spacer 300. Specifically, an object-side surface of the flange portion 130 may contact an image-side surface of the support portion 310. For convenience of explanation, the object side may be referred to as an upper side, and the image side may be referred to as a lower side. An upper surface of the flange portion 130 may be disposed to face a lower surface of the support portion 310. Additionally, the upper surface of the flange portion 130 may be disposed in contact with the lower surface of the support portion 310.

The cut side surface 110 of the first lens 100 may be disposed to face the side wall portion 320 of the spacer 300. That is, the cut side surface 110 may be disposed to overlap the side wall portion 320 in a direction perpendicular to the optical axis. However, in this example, the cut side surface 110 may be disposed such that a portion of the cut side surface overlaps a portion of the side wall portion 320 in a direction perpendicular to the optical axis.

A distance from the upper surface of the support portion 310 to the lower surface of the support portion 310 may be defined as a thickness (t1) of the support portion 310, and a distance from the upper surface of the side wall portion 320 to the lower surface of the side wall portion 320 may be defined as a thickness (t2) of the side wall portion 320.

A length (Lw) of the side wall portion 320 may be shorter than a length (Ld) of the cut side surface 110. Since the spacer 300 is disposed inside the lens barrel 400, in order to properly utilize a space inside the lens barrel 400, the length (Lw) of the side wall portion 320 may be determined to be shorter than the length (Ld) of the cut side surface 110. Specifically, the length (Lw) of the side wall portion 320 may be determined to be shorter than the length (Ld) of the cut side surface, and may be determined to be longer than ½ of the length (Ld) of the cut side surface. That is, the length (Ld) of the side wall portion 320 may be determined within a range satisfying the condition Ld/2<Lw<Ld.

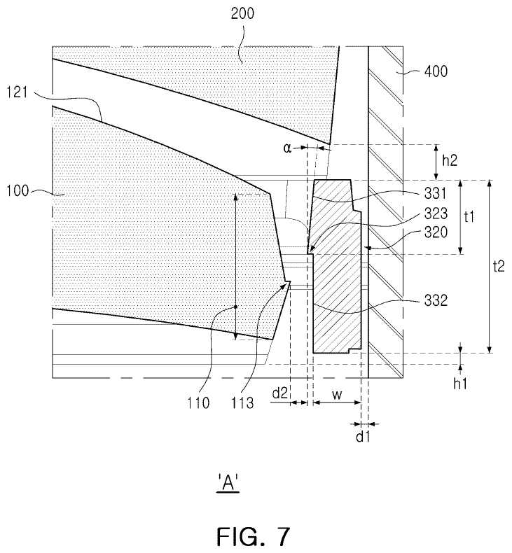

FIG. 7 is an enlarged view of A in FIG. 2.

Referring to FIG. 7, the first lens 100 may include an optical surface 121 and a cut side surface 110. The optical surface 121 and the cut side surface 110 may be directly connected.

As described above, the cut side surface 110 refers to a portion of the side surface of the first lens 100. A first protruding portion 113 may be disposed on the cut side surface 110. The first protruding portion 113 may refer to a portion protruding from the cut side surface 110 of the first lens 100 in a direction in which a distance from an optical axis increases.

Since the first lens 100 is manufactured by injection molding, an injection line formed by a boundary between a plurality of molds may be formed on a side surface of the first lens 100. The first protruding portion 113 of the first lens 100 may be an injection line formed on the side surface of the first lens 100.

A second protruding portion 323 may be disposed on the side wall portion 320. The second protruding portion 323 may refer to a portion that protrudes from the inner surface of the side wall portion 320 in a direction toward an optical axis.

Since the spacer 300 may also be manufactured by injection molding, an injection line formed by a boundary between a plurality of molds may be formed on the side wall portion 320, and the injection line of the side wall portion 320 may correspond to the second protruding portion 323.

In an example, the second protruding portion 323 of the side wall portion 320 may be disposed on the same plane perpendicular to a lower surface of the support portion 310 and the optical axis. That is, the lower surface of the support portion 310 may be disposed at the boundary between the plurality of molds for manufacturing the spacer 300. When the spacer 300 is not manufactured by injection molding, the injection line may not be formed. However, in this example, the second protruding portion 323 may refer to a portion located on the same plane as the lower surface of the support portion 310.

The side wall portion 320 may have a thickness. A thickness (t2) of the side wall portion 320 may be defined as a distance from an upper surface of the side wall portion 320 to the lower surface of the side wall portion 320. That is, the thickness (t2) of the side wall portion 320 may refer to a height of the side wall portion 320 in an optical axis direction.

The thickness (t2) of the side wall portion 320 may be greater than the thickness (t1) of the support portion. In this example, the thickness (t2) of the side wall portion 320 may be greater than the thickness (t1) of the support portion. In this example, the thickness (t2) of the side wall portion 320 may be determined to be greater than a distance from an upper surface of the side wall portion 320 to the first protruding portion 113 of the cut side surface 110 in the optical axis direction. Additionally, the thickness (t2) of the side wall portion 320 may be shorter than the distance from the upper surface of the side wall portion 320 to a lower surface of the flange portion 130 of the first lens 100 in the optical axis direction. That is, the lower surface of the flange portion 130 and the lower surface of the side wall portion 320 may be spaced apart from each other by a third separation distance h1 in the optical axis direction. In this example, the lower surface of the side wall portion 320 may be disposed closer to an object side than to the lower surface of the flange portion 130. Accordingly, the lower surface of the side wall portion 320 may be located between the first protruding portion 113 and the lower surface of the flange portion 130 based on the optical axis direction.

The side wall portion 320 may be disposed between the first lens 100 and the lens barrel 400 to fill a separation space formed between the first lens 100 and the lens barrel 400. Through this structure, it is possible to prevent deformation of the lens assembly due to external force.

The side wall portion 320 may be spaced apart from the inner surface of the lens barrel 400 in a direction perpendicular to the optical axis. A distance at which the side wall portion 320 and the inner surface of the lens barrel 400 are spaced may be referred to as a first separation distance d1.

The cut side surface 110 and the side wall portion 320 may be disposed to be spaced apart in a direction perpendicular to the optical axis. The shortest distance between the cut side 110 and the side wall portion 320 may be defined as a second separation distance d2. Since the second separation distance d2 is the shortest distance between the cut side surface 110 and the side wall portion 320, the second separation distance d2 may be defined as a distance between the protruding portion 113 of the cut side surface 110 and the second protruding portion 323 of the side wall portion 320 based on the direction perpendicular to the optical axis.

The side wall portion 320 is disposed between the lens barrel 400 and the first lens 100 and is disposed to be spaced apart from the lens barrel 400 and the first lens 100. Dimensional tolerances may occur when manufacturing the spacer 300, the first lens 100, or the lens barrel 400. Since the side wall portion 320 is manufactured to be spaced apart from the lens barrel 400 and the first lens 100 in a direction perpendicular to the optical axis, it is possible to prevent assembly defects in the lens assembly which occur when the side wall portion 320 and the lens barrel 400 or the first lens 100 contact due to dimensional tolerances.

The cut side surface 110 and the side wall portion 320 may overlap in a direction perpendicular to the optical axis. Based on FIG. 7, the entire cut side surface 110 is shown to overlap the side wall portion 320 in a direction perpendicular to the optical axis, but the one or more examples are not limited thereto.

The inner surface of the side wall portion 320 may be divided into an upper side surface 331 and a lower side surface 332. In an example, the upper side surface 331 may refer to a surface disposed above the second protruding portion 323 of the side wall portion 320, or on an object side with respect to the second protruding portion 323 of the side wall portion 320. The lower side surface 332 may refer to a surface disposed below the second protruding portion 323 of the side wall portion 320, or on an image side with respect to the second protruding portion 323 of the side wall portion 320. The upper side surface 331 may have an inclination angle (a) based on a line parallel to an optical axis. The inclination angle (a) may be an acute angle. The inclination angle (a) may be determined considering rigidity of the spacer 300. Specifically, as the inclination angle (a) increases, the thickness of an upper side wall portion 320 of the spacer 300 becomes thinner. When the thickness of the upper side wall portion 320 becomes too thin, the rigidity of the spacer 300 may not be sufficient and the spacer 300 may be bent. Accordingly, a size of the inclination angle α may be determined considering the rigidity of the spacer 300. For example, a range of inclination angle may satisfy 0.1°<a<60°.

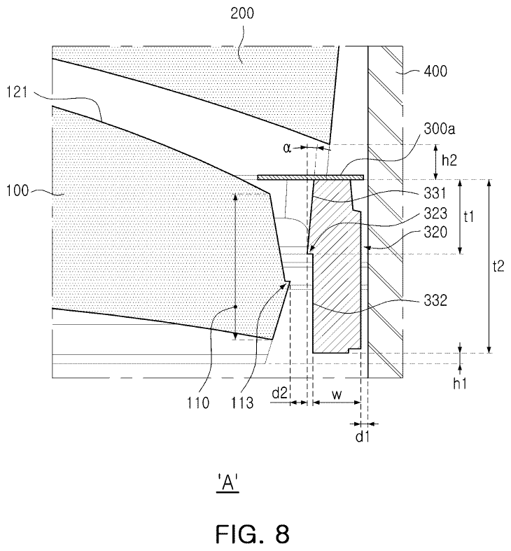

FIG. 8 illustrates another embodiment of an example lens assembly, in accordance with one or more embodiments. Regarding the embodiment of FIG. 8, description of the same content as the embodiment described above may be omitted.

Referring to FIG. 8, a second spacer 300a is disposed between the second lens 200 and the first spacer 300. That is, the first spacer 300 indirectly supports the second lens 200 based on the second spacer 300a. A height of the second spacer 300a may be less than the height of the first spacer 300. In an example, the height refers to a height in an optical axis direction.

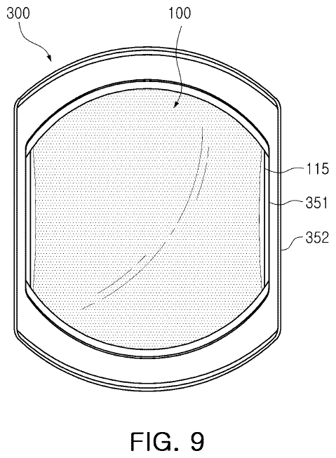

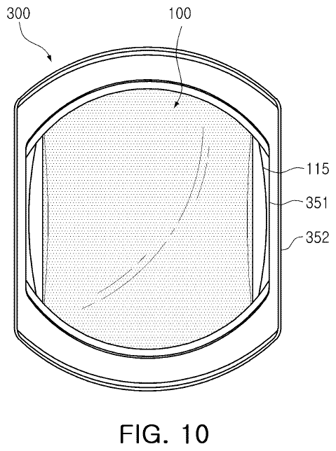

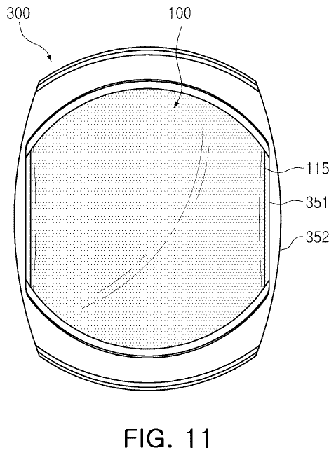

FIGS. 9 to 11 illustrate various embodiments of the lens assembly, in accordance with one or more embodiments, illustrating a structure of a cut side surface and a side wall portion. A structure of a spacer coupled to the first lens is illustrated as viewed from an object side. Descriptions of contents the same as those of the previous embodiment will be omitted.

Referring to FIG. 9, based on a view from the object side, the cut side surface 110 may be referred to as a side portion 115 of the lens. In an example, the side portion 115 of the lens may be provided in a straight-line shape, and an inner surface 351 of the side wall portion and an outer surface 352 of the side wall portion may also be provided in a straight-line shape. The inner surface 351 of the side wall portion and the outer surface 352 of the side wall portion may be disposed to be parallel to a direction perpendicular to the optical axis.

Referring to FIG. 10, when viewed from the object side, the side portion 115 of the lens may have a straight shape. The inner surface 351 of the side wall portion may have a curved shape with a center of a radius of curvature disposed toward an optical axis, and the outer surface 352 of the side wall portion may have a straight shape.

In this example, the side portion 115 of the lens and the outer surface 352 of the side wall portion may be parallel in a direction perpendicular to the optical axis.

Referring to FIG. 11, when viewed from the object side, the side portion 115 of the lens may have a straight shape. The inner surface 351 of the side wall may have a straight shape, and the outer surface 352 of the side wall may have a curved shape with a center of a radius of curvature disposed toward an optical axis.

In this example, the side portion 115 of the lens and the inner surface 351 of the side wall portion may be parallel in a direction perpendicular to the optical axis.

Referring to FIG. 12, when viewed from the object side, the side portion 115 of the lens may have a straight shape. Each of the inner surface 351 of the side wall portion and the outer surface 352 of the side wall portion may have a curved shape with a center of a radius of curvature disposed toward an optical axis.

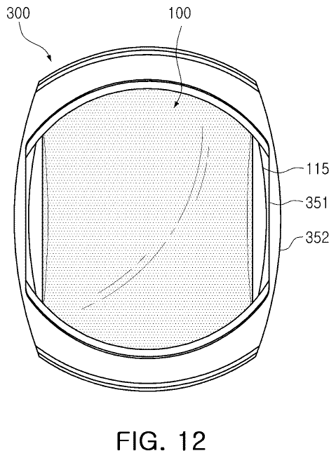

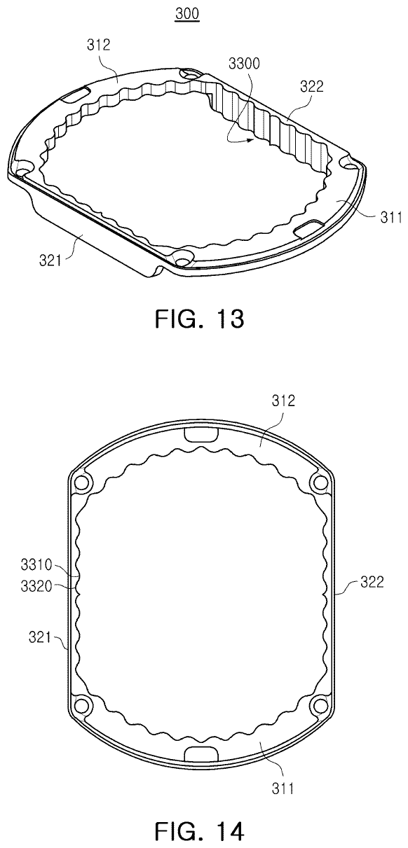

FIG. 13 is a perspective view illustrating another embodiment applied to an example lens assembly, in accordance with one or more embodiments, and FIG. 14 is a plan view illustrating a spacer of another embodiment. Descriptions of contents the same as those previously described in relation to the spacer will be omitted below.

Referring to FIGS. 13 and 14, a wave-shaped portion 3300 may be disposed on an inner peripheral surface of the spacer 300. The wave-shaped portion 3300 may include a valley 3320 and a crest 3310. When the spacer 300 is assembled with the lens barrel 400 and the lens to form a lens assembly, light may be reflected from the inner surface of the spacer 300.

The light reflected from the inner surface of the spacer 300 may be reduced by the wave-shaped portion 3300 disposed on the inner surface of the spacer 300. Specifically, when light is incident on the inner surface of the spacer 300, the light may be incident on the valley 3320 of the wave-shaped portion 3300. The light incident on one part of the valley 3320 of the wave-shaped portion 3300 may be reflected to another part of the valley 3320. That is, the light incident on the valley of the wave-shaped portion 3300 may be reflected within the valley 3320 of the wave-shaped portion 3300, and a flare phenomenon may be reduced by forming destructive interference between the reflected light portions.

According to the above-described embodiment, the structural stability of the lens assembly may be secured based on a structure of the side wall portion 320 of the spacer 300 disposed between the cut side surface 110 of the first lens 100 and the inner surface of the lens barrel 400. Additionally, the flare phenomenon may be reduced based on the side wall portion of the spacer facing the cut side surface 110 of the first lens 100 in a direction perpendicular to the optical axis.

As set forth above, according to the one or more embodiments, the structural stability of the lens assembly may be improved by disposing a side wall portion of a spacer in a space between the lens and the lens barrel.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A lens assembly, comprising:
a spacer; and
a first lens coupled to the spacer,
wherein a length of the first lens in a first direction, perpendicular to an optical axis, is greater than a length of the first lens in a second direction, perpendicular to both the optical axis and the first direction,
wherein the first lens comprises a first side surface which extends in the first direction,
wherein the spacer comprises a plurality of support portions in contact with the first lens, and a side wall portion that connects the plurality of support portions, and
wherein the first side surface of the first lens is disposed to face the side wall portion.

2. The lens assembly of claim 1, wherein the first side surface of the first lens is disposed to be spaced apart from the side wall portion in a direction perpendicular to an optical axis.

3. The lens assembly of claim 1, wherein a first protruding portion, which protrudes in a direction in which a distance from the optical axis increases, is disposed on the first side surface of the first lens, and
wherein the first protruding portion is disposed to be spaced apart from the side wall portion in a direction perpendicular to the optical axis.

4. The lens assembly of claim 1, wherein a length of the side wall portion is less than a length of the first side surface of the first lens.

5. The lens assembly of claim 4, wherein when the length of the first side surface of the first lens is Ld, and the length of the side wall portion is Lw,
Ld/2<Lw<Ld is satisfied.

6. The lens assembly of claim 1, wherein a thickness of the side wall portion in an optical axis direction is greater than a thickness of the support portion in the optical axis direction.

7. The lens assembly of claim 1, wherein the first lens comprises an optical portion and a flange portion that extends from the optical portion, and
wherein a lower surface of the flange portion is disposed closer to an image side in the optical axis direction than to a lower surface of the side wall portion.

8. The lens assembly of claim 3, wherein the first lens comprises an optical portion and a flange portion that extends from the optical portion, and
wherein a lower surface of the side wall portion is disposed between the first protruding portion and a lower surface of the flange portion based on a direction parallel to the optical axis.

9. The lens assembly of claim 3, wherein an inner surface of the side wall portion comprises a second protruding portion which protrudes toward the optical axis, and
the first protruding portion and the second protruding portion are spaced apart from each other in a direction perpendicular to the optical axis.

10. The lens assembly of claim 1, wherein when viewed from an object side, the first side surface of the first lens and an inner surface of the side wall portion are disposed to be parallel to each other.

11. The lens assembly of claim 1, wherein when viewed from an object side, an inner surface of the side wall portion has a curved shape with a center of a radius of curvature disposed on a side of the optical axis.

12. A lens assembly, comprising:
a lens barrel;
a spacer disposed on the lens barrel; and
a first lens disposed on the lens barrel and coupled to the spacer,
wherein a length of the first lens in a first direction, perpendicular to an optical axis, is greater than a length of the first lens in a second direction, perpendicular to both the optical axis and the first direction,
wherein the first lens comprises a first side surface which extends in the first direction,
wherein the spacer comprises a plurality of support portions in contact with the first lens and a side wall portion that connects the plurality of support portions,
wherein the side wall portion faces the first side surface of the first lens in a direction perpendicular to an optical axis, and
wherein the side wall portion is disposed to be spaced apart from an inner surface of the lens barrel in a direction perpendicular to the optical axis.

13. The lens assembly of claim 12, wherein the first side surface of the first lens is disposed to be spaced apart from an inner surface of the side wall portion in a direction perpendicular to the optical axis.

14. The lens assembly of claim 12, wherein a protruding portion which protrudes toward the optical axis is disposed on an inner surface of the side wall portion,
wherein the inner surface of the side wall portion comprises an upper side surface disposed above the protruding portion, and
wherein the upper side surface is configured to form an acute angle with a line parallel to the optical axis.

15. The lens assembly of claim 12, wherein the first lens comprises an optical portion and a flange portion that extends from the optical portion, and
wherein a lower surface of the support portion is disposed in contact with an upper surface of the flange portion.

16. The lens assembly of claim 12, wherein a length of the side wall portion is less than a length of the first side surface of the first lens.

17. A lens assembly, comprising:
a first lens comprising cut side surfaces, and comprising a first length in a first direction perpendicular to an optical axis, and a second length, less than the first length, in a second direction perpendicular to both the optical axis and the first direction; and
a first spacer, comprising support portions and sidewall portions,
wherein the sidewall portions are spaced apart from the cut side surfaces of the first lens, overlap the cut side surfaces of the first lens in a direction perpendicular to an optical axis direction, and extend from an upper surface of the spacer toward an imaging plane.

18. The lens assembly of claim 17, further comprising a second spacer disposed between a second lens and the first spacer,
wherein a height of the second spacer in an optical axis direction is less than a height of the first spacer in the optical axis direction.

19. The lens assembly of claim 17, wherein inner surfaces of the side wall portions have a curved shape with a center of a radius of curvature disposed toward the optical axis, and outer surfaces of the side wall portions have a straight shape.
